(19) United States
(12) Patent Application Publication
(10) Pub. No.: US 2003/0163729 A1
(43) Pub. Date: Aug. 28, 2003

(54) Security management in data processing networks

(75) Inventor: Sonja Buchegger, Zurich (CH)

Correspondence Address: IBM CORPORATION, INTELLECTUAL PROPERTY LAW DEPT., P.O. BOX 218 - 39 -254, YORKTOWN HEIGHTS, NY, 10598, US

(73) Assignee: International Business Machines Corporation

(21) Appl. No.: 10/085,457

(22) Filed: Feb. 27, 2002

(51) Int. Cl. G06F 11/30

(52) U.S. Cl. 713/201

(57) ABSTRACT

Described is a method, apparatus, and computer program product for security management in a node of a data processing network comprising a plurality of nodes, wherein each node maintains topology data representing the network. The method comprises evaluating an event received by the node from a neighboring node in the network to determine if the event satisfies a predetermined security test. If the event fails the security test, an entry associated with the neighboring node is modified in the topology data maintained by the node, and an alarm notification indicative of the security failure is sent to other nodes of the network.

### TECHNICAL FIELD

The present invention generally relates to security management in data processing networks and particularly relates methods, apparatus, and computer program products for security management in a node of a data processing network.

### BACKGROUND

A data processing network typically comprises a plurality of data processing node interconnected by a communication networks. Each data processing node typically comprises a processor such as a microprocessor, a memory, an input/output (I/O) interface for connecting the node to the network, and bus interconnecting the processor, memory and interface. Data processing networks can predefined or alternatively come into being on an ad-hoc basis.

Ad-hoc networks are typically formed between a plurality of mobile data processing nodes such a wireless data processing devices. Such data processing devices typically communicate with each other in an ad-hoc network by radio frequency, infra red, or similar wireless communication medium. Mobile ad-hoc networks typically do not rely on any fixed communication infrastructure. Instead, nodes in such networks communicate in a self-organized manner, relaying messages originated by other nodes. These networks work properly provided that the participating nodes collaborate in routing and forwarding. However, nodes in such networks may choose not to collaborate. It would be desirable to detect and isolate such nodes, thus making it unattractive for participating nodes to deny collaboration. An example of a mobile ad-hoc network is the Terminodes network described in [1]. In the Terminodes network, devices act as nodes and terminals simultaneously and forward packets destined for other nodes. Another example of a mobile ad-hoc network is the MANET network described in [2]. A routing protocol associated with the MANET network is the Dynamic Source Routing (DSR) protocol. The Terminodes network is a wide area, self organized network. The MANET network is not such a network. It would desirable to provide incentives for nodes in such networks to collaborate with each other in the interests of improving flow of messages within the network.

As indicated in [3], there are many information security issues associated with data networks, including those of authentication, integrity, confidentiality, availability, access control, and non-repudiation. Security in mobile ad-hoc networks cannot be readily addressed in the same way it is addressed in infrastructure based networks because mobile ad-hoc networks are vulnerable to attacks which are not experienced in infrastructure-based networks. Additional security issues associated with mobile ad-hoc networks will now be briefly discussed.

Although not generally an issue for infrastructure based networks, it is desirable in mobile ad hoc networks for there to be an incentive for a node to forward messages that are not destined for itself. Nodes in such networks can be greedy, selfish, and economic in the forwarding of messages. Attacks on such networks include: incentive mechanism exploitation by message interception, copying, or forging; incorrect forwarding; and, bogus routing advertisements. If a node does not forward messages, other nodes might not forward either, thereby denying service within the network. A lack of collaboration with other nodes and exploitation of the willingness of other nodes to collaborate is an example of a boycotting behavior pattern. A node may choose not to collaborate with other nodes, exploit the willingness of the other nodes to collaborate, and then restrict access of those other nodes to its own resources. Such a node thus deprives other nodes of its resources while simultaneously exploiting the resources of the other nodes.

As indicated in [4], routing information can be at least equally important as message content. It can be desirable therefore to protect the privacy of routing information in the interests of maintaining secrecy in the whereabouts of a given node. This however prevents the use of routing information by intermediate nodes in the network. It is desirable for routes in a network to be established and advertised based on a selected protocol. However, by diverting traffic, nodes can work against this. For example, to obtain information for malicious behavior, a node can attract traffic to itself or to colluding nodes by sending false routing advertisements. There are many different techniques for creating a false route that exhibits properties of a good route and is subsequently preferred over genuine routes. Such false routes can be made to remain longer in routing caches. To avoid raising suspicion, nodes can keep copies of received messages as the messages are forwarded to the intended destination. It will be appreciated that much information for formulating network attacks can be gathered in this manner. For example, denial of service attacks can be achieved by injecting false routing information or by otherwise distorting routing information to partition the network or to introduce excessive loading in the network. A node can also forward messages to colluding nodes for analysis, disclosure and the like. Similarly, a node may choose not to forward messages at all, thereby boycotting communications.

The limited infrastructure and organization within ad-hoc networks offers enhanced opportunities for network attacks. Without proper security, it is possible to gain various unfair advantages by misbehavior, including: better service than cooperating nodes, monetary benefits by exploiting incentive measures or trading confidential information; saving power by selfish behavior; and, preventing others from obtaining adequate service.

A node exhibiting one or more of the undesirable behavior patterns herein before described will be herein after referred to as a malicious node.

Described in [5] is a scheme for authenticating users by “imprinting” according to the analogy with ducklings acknowledging the first moving object they see as their mother, but enabling nodes to be imprinted several times. In [6], threshold security is employed, permitting several corrupted nodes or collusion between such nodes. In [7], network security based on distance vector protocols is described. As indicated in [8], incentives for nodes to collaborate via a so-called nuglet serving as a per-hop payment in each packet have been suggested to ensure message forwarding. In [9], increased throughput in mobile ad-hoc networks is achieved by complementing DSR with a watchdog for detection of malicious behavior and a path rater for trust management and routing policy. This permits nodes to route around malicious nodes. However, a problem associated with the scheme relates to scalability, because every node in the network keeps a rating of every other node. This is not suitable for “open world” networks such as the aforementioned Terminodes network because the memory requirements associated with maintaining ratings would be too burdensome. The scheme relieves malicious nodes that do not collaborate from the burden of forwarding messages for others, whereas messages from the malicious nodes are forwarded without complaint. Thus, malicious nodes are effectively rewarded for misbehavior and thus encouraged to misbehave. Although the overall network throughput is increased, the failure to collaborate is undesirable. It would be desirable for malicious behavior and non-collaboration in the network to be punished. Detection of malicious behavior alone is insufficient. It would be preferable for the detection to cause a reaction in other nodes that makes malicious behavior disadvantageous.

### SUMMARY OF THE INVENTION

In accordance with the present invention, there is now provided a method for security management in a node of a data processing network comprising a plurality of nodes, wherein each node maintains topology data representing the network, the method comprising: evaluating an event received by the node from a neighboring node in the network to determine if the event satisfies a predetermined security test; and, if the event fails the security test, modifying an entry associated with the neighboring node in the topology data maintained by the node, and sending an alarm notification indicative of the security failure to other nodes of the network.

The sending step may include sending the alarm notification to all other nodes in the network. The evaluating of the event received from the neighboring node may comprise: counting the number of occurrences of the event in a predetermined time interval; incrementing a rating of the neighboring node if the number of occurrences exceeds a predetermined event occurrence threshold; and, determining that the event fails the security test if the rating of the neighboring node exceeds a predetermined rating threshold. A preferred embodiment of the present invention comprises: receiving an alarm notification generated by another node in the network, the received alarm notification being indicative of an event caused by a further node in the network; evaluating the alarm notification received generated by the other node to determine if the other node satisfies a predetermined trust test, and, evaluating the event indicated by the alarm notification if the other node passes the trust test to determine if the event indicated by the alarm notification satisfies the security test; and, if the event fails the security test, modifying an entry associated with the event causing node in the topology data maintained by the node, and sending another alarm notification indicative of the security failure to any neighboring nodes. The evaluating of the event indicated by the alarm notification may comprise: counting the number of occurrences of the event indicated by the alarm notification in a predetermined time interval; incrementing a rating of the event causing node if the number of occurrences exceeds a predetermined event occurrence threshold; and, determining that the event fails the security test if the rating of the event causing node exceeds a predetermined rating threshold.

Viewing the present invention from another aspect, there is now provided a computer program product comprising a computer readable medium having embodied therein computer readable program code means for causing a processor of a node in a data processing network comprising a plurality of nodes to perform a method for security management in the node, wherein each node maintains topology data representing the network, the method comprising: evaluating an event received by the node from a neighboring node in the network to determine if the event satisfies a predetermined security test; and, if the event fails the security test, modifying an entry associated with the neighboring node in the topology data maintained by the node, and sending an alarm notification indicative of the security failure to any other nodes of the network.

Viewing the present invention from yet another aspect, there is now provided apparatus for security management in a node of a data processing network comprising a plurality of nodes, wherein each node maintains topology data representing the network, the apparatus comprising control logic configured to evaluate an event received by the node from a neighboring node in the network to determine if the event satisfies a predetermined security test, to modify an entry associated with the neighboring node in the topology data maintained by the node if the event fails the security test, and to send an alarm notification indicative of the security failure to other nodes in the network.

Viewing the present invention from still another aspect, there is now provided a data processing node for connection to a data processing network comprising a plurality of nodes, wherein each node maintains topology data representing the network, the data processing node comprising: a memory for storing the topology data; and, security management control logic connected to the memory and configured to evaluate an event received by the node from a neighboring node in the network to determine if the event satisfies a predetermined security test, to modify an entry associated with the neighboring node in the topology data stored in the memory if the event fails the security test, and to send an alarm notification indicative of the security failure to other nodes of the network.

Viewing the present invention from a further aspect, there is now provided a data processing network comprising a plurality of data processing nodes, wherein each node maintains topology data representing the network, each of the data processing nodes comprising: a memory for storing the topology data; and, security management control logic connected to the memory and configured to evaluate an event received by the node from a neighboring node in the network to determine if the event satisfies a predetermined security test, to modify an entry associated with the neighboring node in the topology data stored in the memory if the event fails the security test, and to send an alarm notification indicative of the security failure to any other nodes of the network.

In a preferred embodiment of the present invention, trust relationships and routing decisions are made based on the experienced, observed, or reported message routing and forwarding behavior of other nodes. This is analogous to a biological system described in [10], in which there are “suckers, “cheats” and “grudgers”. The suckers always help others, the cheats have others help them but fail to return the favor, and the grudgers start by helping all others, but subsequently only helps those that return the favor. The grudgers are found to prevail over time.

In a particularly preferred embodiment of the present invention, storage and processing requirements in each node of the network are minimized by each node employing a localized neighborhood watch for generating a warning of malicious behavior based on observation of neighboring nodes, and by each node sharing with the other nodes information relating to malicious behavior experienced.

### BRIEF DESCRIPTION OF THE DRAWINGS

Preferred embodiments of the present invention will now be described, by way example only, with reference to the accompanying drawings, in which:

FIG. 1 is a block diagram of a data processing network;

FIG. 2 is a block diagram of a data processing node of the network;

FIG. 3 is a flow diagram corresponding to security management control logic of the node;

FIG. 4 is another flow diagram corresponding to security management control logic of the node;

FIG. 5 is yet another flow diagram corresponding to security management control logic of the node;

FIG. 6 is a block diagram of security management control logic of the node;

FIG. 7 is a block diagram of a monitor of the control logic;

FIG. 8 is a block diagram of a trust manager of the control logic;

FIG. 9 is a block diagram of a reputation manager of the control logic;

FIG. 10 is a block diagram of a path manager of the control logic;

FIG. 11 is a block diagram of a block diagram of the data network showing flow of routing requests;

FIG. 12 is a block diagram of a block diagram of the data network showing flow of routing replies;

FIG. 13 is a block diagram of a block diagram of the data network showing flow of data messages and an ALARM message;

FIG. 14 is a block diagram of the data network showing flow of an acknowledgment and rerouting of the data messages; and,

FIG. 15 is a state diagram of the control logic.

### DETAILED DESCRIPTION OF THE PREFERRED EMBODIMENT

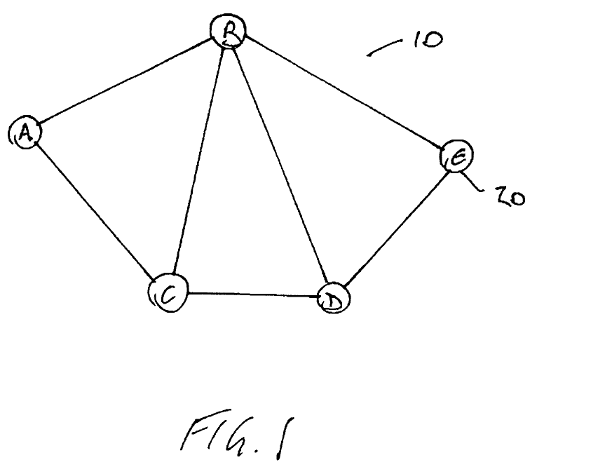

Referring first to FIG. 1, an example of a data processing network 10 comprises a plurality of interconnected data processing nodes 20, here labeled A, B, C, D and E. In operation, the nodes 20 communicate messages with each other via the network 10. It will be appreciated that the network 10 can be a distributed network, local area network, wide area network, campus network, wired network, wireless network, or other type of network. In a preferred embodiment of the present invention, the network is in the form of a mobile ad-hoc network. Similarly, it will be appreciated that each of the data processing nodes may be embodied in any one of a range of different forms, such as a mobile computer, personal digital assistant, desk top computer, mobile phone or the like.

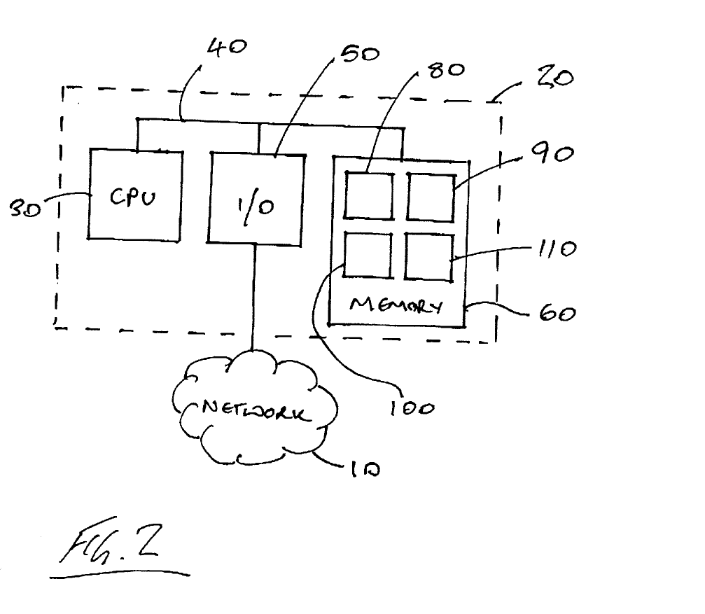

Referring now to FIG. 2, each of the nodes 20 comprises a processor 30, an input/output (I/O) subsystem 50, and a memory 60, all interconnected by a bus subsystem 40. The I/O subsystem 50 comprises at least one user input device such as a keyboard, keypad, mouse, microphone, or the like. Similarly, the I/O subsystem 50 comprises at least one user output device such as a display, loudspeaker, printer or the like. In addition, the I/O subsystem 50 comprises a network interface device for connecting the node 20 to the network 10. The processor 30 comprises a central processing unit such as a microprocessor or the like. The memory 60 includes a random access memory and a read only memory. In operation, the processor 30 executes computer program instruction code stored in the memory 60. The computer program code includes operating system software 80, application program software 90, and networking software 100, for execution in conjunction with operating system software 80. The networking software 100 may be embedded in the operating system software 80. The application program software 90 operates on data stored in the memory 60. The user can control execution of the application software 90 via the I/O subsystem 50. The networking software 100 facilitates communication of application software and data in message form between the memory subsystem 60 and other nodes in the network 10 via the I/O subsystem 50. To facilitate communication with other nodes 20 in the network 10, topology data 110 containing entries indicative of the nodes 20 of the network together with paths and links between them is also stored in the memory 60 and maintained by the networking software 100. The networking software 100 comprises computer program code which when executed by processor 30, establishes security management control logic within the node 20. It will be appreciated that control logic, in this embodiment of the present invention, is embodied in computer program code resident in the memory 60 and executable by the processor 30. However, it will be equally appreciated that, in other embodiment of the present invention, the control logic may be at least partially implemented by hardwired logic circuitry in the node 20.

Referring now to FIG. 3, the security management control logic is configured to evaluate at 210 an event received at 200 by the node 20 from a neighboring node 20 in the network 10 to determine at 220 if the event satisfies a predetermined security test. If the event fails the test, an entry associated with the neighboring node in the topology data 110 maintained by the node is modified and at 240 an alarm notification indicative of the security failure is sent to any other neighboring nodes. The modification of the topology data entry corresponding to the neighboring node may involve flagging the neighboring node or paths involving the neighboring node such that paths involving the neighboring node are subsequently avoided or selected only in extreme circumstances. Alternatively or additionally, the neighboring node may be flagged such that messages subsequently received from the neighboring node are handled with greater care and scrutiny. In some embodiments of the present invention, the alarm notification may be sent to all neighboring nodes.

In the network 10, the nodes 20 most likely to detect misbehavior are those in the vicinity of a misbehaving node. In some cases, the source and destination of a message can also detect misbehavior based on unusual responses received.

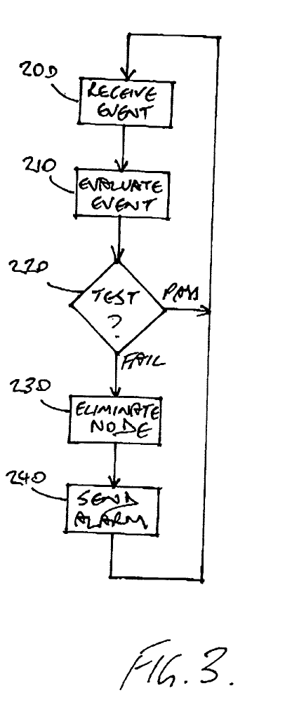

Referring to FIG. 4, in a preferred embodiment of the present invention, the control logic is configured such that evaluating the event received from the neighboring node comprises counting at 300 the number of occurrences of the event in a predetermined time interval. If, at 310, the number of occurrences exceeds a predetermined event occurrence threshold, the rating of the neighboring node is incremented at 320. If at 330 the rating of the neighboring node exceeds a predetermined rating threshold, the control logic 100 determines at 340 that the event fails the security test. Otherwise the event is passed at 350.

Referring to FIG. 5, in a preferred embodiment of the present invention, the control logic is additionally configured to receive at 400 an alarm notification generated by another node in the network 10 and indicative of an event caused by a further node in the network 10. At 410, the control logic evaluates the received alarm notification to determine if the other node satisfies a predetermined trust test. If, at 410, the control logic finds that the other node is trusted, and thus passes the trust test, the control logic evaluates the event indicated by the alarm notification to determine if the event indicated by the alarm notification satisfies the security test. If at 430 the event indicated by the alarm notification fails the security test, the control logic modifies an entry corresponding to the event causing node in the topology data 110 maintained by the node and, at 450, sends another alarm notification indicative of the security failure to any neighboring nodes. The modification of the entry corresponding to the event causing node may be substantially as herein before described with reference to FIG. 3.

In a particularly preferred embodiment of the present invention, the control logic is configured such that the evaluation of the event indicated by the alarm notification is performed in a similar manner to that herein before described with reference to FIG. 4 in that it comprises: counting the number of occurrences of the event indicated by the alarm notification in a predetermined time interval; incrementing a rating of the event causing node if the number of occurrences exceeds a predetermined event occurrence threshold; and, determining that the event indicated by the alarm notification fails the security test if the rating of the event causing node exceeds a predetermined rating threshold.

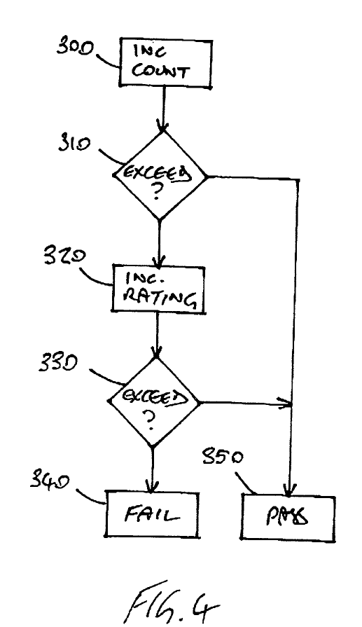

Referring now to FIG. 6, in a particularly preferred embodiment of the present invention, the control logic comprises a monitor 500, a reputation manager 520, a path manager 530, and a trust manager 510, all interconnected.

In operation, the monitor 500 performs a neighborhood watch function in which it observes local neighbor nodes for the purpose of detecting misbehavior such as intrusion, misuse of collaboration incentives, and denial of services. When misbehavior is detected, behavioral conditioning is performed by the nodes neighboring the malicious node.

As indicated earlier with reference to FIGS. 3 and 5, each node 20 in the network 10 acts upon its own observations and upon ALARM messages received from other nodes 20 of the network 10. In the interests of collaboration, each node 20 also informs other nodes 20 in the network 10.

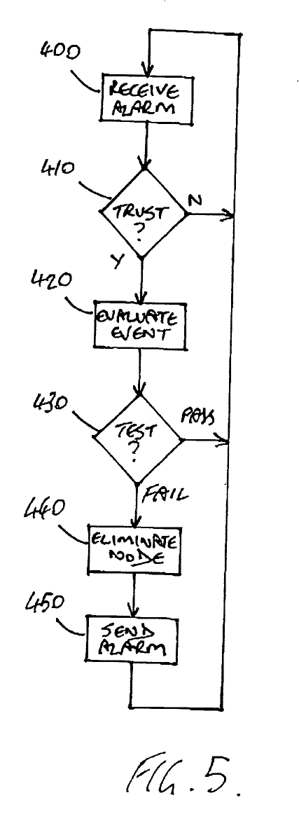

Referring now to FIG. 7, each neighboring node 20 participating in a neighborhood watch detects misbehavior by the next node on a source route by listening to the transmission of the next node or by observing routing protocol behavior. The listening and observing functions are performed in each such node 20 by the monitor 500. Specifically, the monitor 500 receives ALARM messages from other nodes in the network 10 and detects events originating in neighboring nodes. The monitor 500 comprises a watch table 540 for retaining copies of sent messages for event detection. By keeping a copy of a message, listening to the transmission of the next node, and comparing the retained copy with the transmission, any content change indicative of an event is detected. Types of misbehavior thus detected include: no forwarding of control messages or data; unusual traffic attraction, such as advertising of many good routes and advertising routes very fast so that they are deemed good routes; rerouting to avoid a broken link despite there being no error observed; lack of error messages despite an error having been observed; unusually frequent routing updates; and, tampering with the header in either control or data messages.

As will be described shortly, for such types of misbehavior, thresholds are set that may not be exceeded by a node. There are two neighbor types for each source route: the node 20 preceding the observed node 20 in the source route and any node 20 on hop away from the observed node. These two neighbor types have different capabilities. The neighbor node 20 on the same path as the observed node 20 has additional route information from which it can detect whether a message was forwarded to the next hop in the route. Routing protocol behavior on the other hand can be observed by any neighbor within a one hop radius.

As indicated in [11], it is desirable in an ad-hoc network for trust management to be both distributed and adaptive. The trust manager 510 handles incoming ALARM messages received by the monitor 500 from other nodes 20 in the network 10.

Referring to FIG. 8, the trust manager 510 comprises a trust table 550 in which the trust manager 510 assigns a level of trust to other nodes in the network 10. The trust levels are recorded in a trust table 550. ALARM messages received from other nodes in the network 10 by the monitor 510 are assigned the level of trust associated with the node originating the ALARM message in the trust table 550. The trust manager 90 employs a trust function to calculate the trust levels recorded in the trust table 550. ALARM messages are forwarded by the trust manager 510 provided that an acceptable level of trust is associated with the originating node in the trust table 550. The trust manager 510 thus filters incoming ALARM messages are filtered according to the level of trust assigned to the reporting node. The level of trust is employed by the node 20 when deciding whether to provide or accept routing information, whether to accept a node as part of a route, and in whether to take part in a route originated by another node.

In a particularly preferred embodiment of the present invention, the trust manager 500 employs a trust function for routing and forwarding which is similar to that used for key validation and certification in Pretty Good Privacy (PGP) encryption. Further details of PGP can be found in [12].

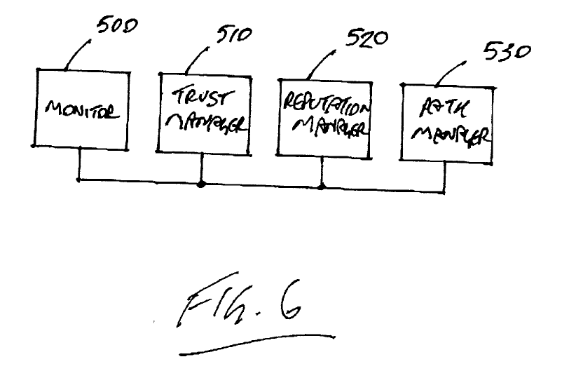

Referring now to FIG. 9, the reputation manager 520 comprises a rating table 560. In operation, the reputation manager 520 performs the function herein before described with reference to FIG. 3. Specifically, the reputation manager 520 stores in the rating table 560 a list of nodes of the network 10 with a rating against each of the listed nodes. As herein before described, the rating assigned to a given node is changed when there is sufficient evidence that the node is misbehaving. This test is realized by determining when the number of events received by the reputation manager 520 in connection with the malicious node exceeds a predetermined level within a predetermined time interval. An event may be detected by the monitor 500 as occurring in a neighboring node. Alternatively, an event may be received by the monitor 500 in an ALARM message generated by another node based on detection by that other node of misbehavior in a further node. The rating associated with the malicious node is then changed in the rating table 560 by the reputation manager 520 according to a rating function. The reputation manager 520 employs the rating function to assign different weights to the events depending on the source of the event. Events detected by the monitor 500 are assigned the greatest weight. ALARM messages based on observations of other nodes are assigned lower weights. Specifically, ALARM messages in the form of reported experiences from other nodes are assigned weight based on the level of trust associated with the reporting node in the trust table 530 maintained by the trust manager 510. It will be appreciated then that there is cooperation between the reputation manager 520 and the trust manager 510. Once the weight of an event has been determined by the reputation manager 520, the rating corresponding to the malicious node in the rating table 560 is modified accordingly. If the rating of the malicious node deteriorates beyond a predetermined tolerance threshold, the reputation manager 520 notifies the path manager 530.

By employing local rating tables maintained at each node 20 of the network 10, centralized rating is avoided. The nodes 20 in the network 10 can include in routing requests indications of malicious nodes to be avoided in routing based on the contents of rating tables 560 individually maintained. Nodes 20 in the network 10 may also exchange rating tables 560 with each other. Furthermore, nodes 20 in the network 10 may look up senders of messages in the rating table 560 before sending anything to them. In particularly preferred embodiments of the present invention, genuinely malicious nodes and false accusations are effectively distinguished from each other by associating time-out periods of entries in the rating tables 560 and trust tables 550, after which the entries are reset. The time out also prevents the tables 550 and 560 becoming too large, thereby facilitating scalability of the network 10.

Referring now to FIG. 10, the path manager 530 comprises the topology data 110. In operation, the path manager 530 stores available forwarding paths in the topology data 110. Paths are deleted if malicious nodes are detected therein by the reputation manager 520. On eliminating a malicious node from the topology data 110, the path manager 530 also instructs the trust manager 510 to issue an ALARM message.

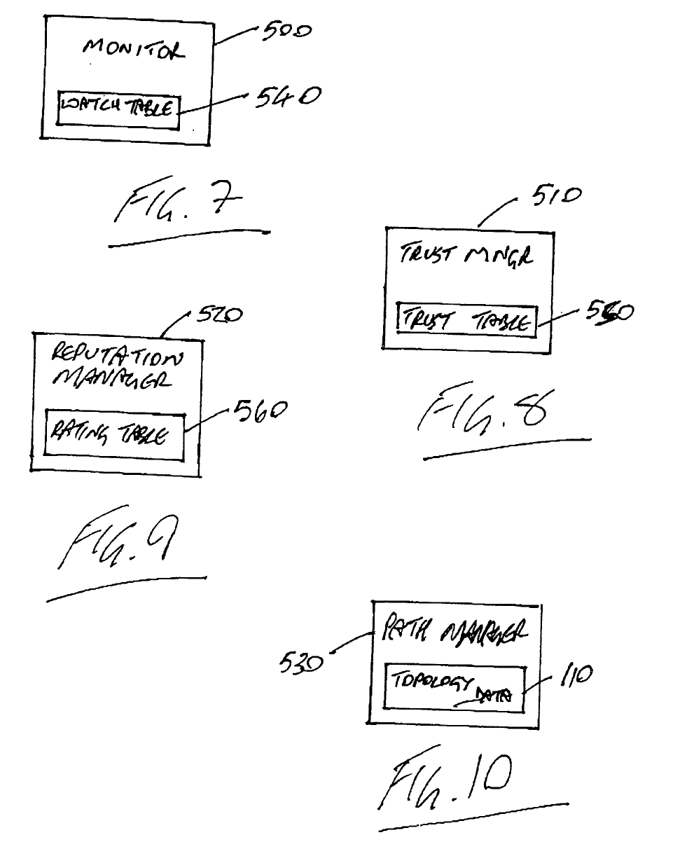

Each ALARM message comprises indications of routing protocol violation type, the number of occurrences detected, whether the message was originated by the sender, the address of the reporting node, the address of the observed node, and the destination address. As herein before described, ALARM messages are sent in response to malicious behavior exceeding a threshold value. By way of example, FIGS. 11 to 14 show flow of messages and data from route discovery to detection of malicious behavior and subsequent rerouting in the network 10 herein before described with reference to FIG. 1.

Referring to FIG. 11, a route is discovered for a path from node A to node E. Specifically a route request is generated at node A and sent to adjacent nodes B and C at 201 and 202. The route request is forwarded by node B to nodes C, D, and E at 203, 204, and 205 respectively. The request is also forwarded by node C to node D at 206.

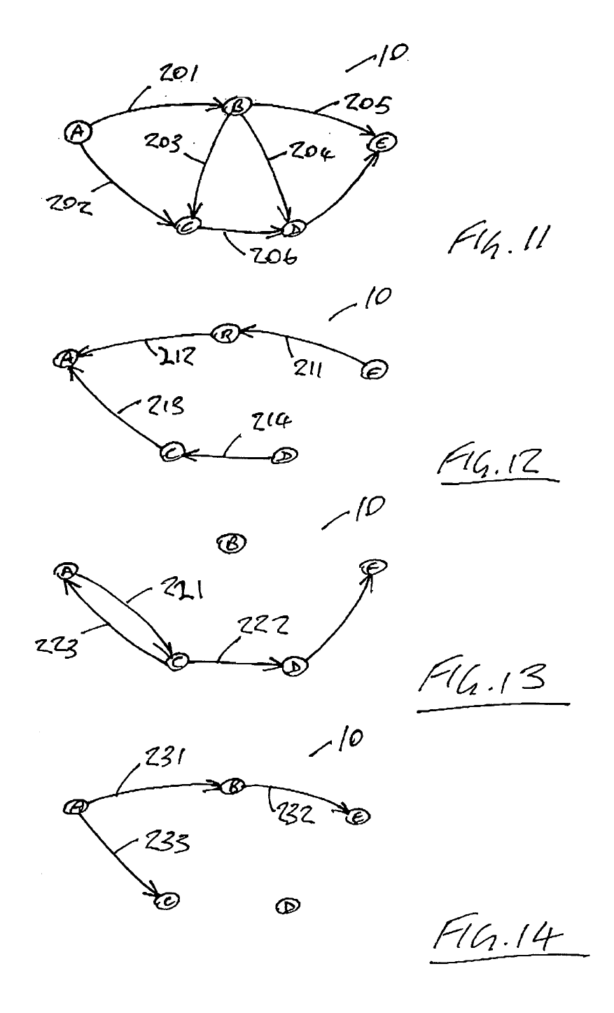

With reference to FIG. 12, node E issues a route reply message which is sent via node B to node A at 211 and 212 respectively. Similarly, node D, which has a path to node E, also sends a route reply message back to node A via node C at 214 and 213 respectively. The reply message contains the reverse source route to the destination node E.

Turning to FIG. 13, node A chooses the route to node E via nodes C and D based on metrics associated with route being referable, according some predetermined routing criteria, to those associated with the route via node B. Data messages are now passed from node A to node E via nodes C and D as indicated at 221 and 222 respectively. In this example however, during the data flow, node C detects that node D is behaving maliciously. On detection in node C that the malicious behavior of node D has exceeded a predetermined threshold, node C issues an ALARM message to node A as indicated at 223.

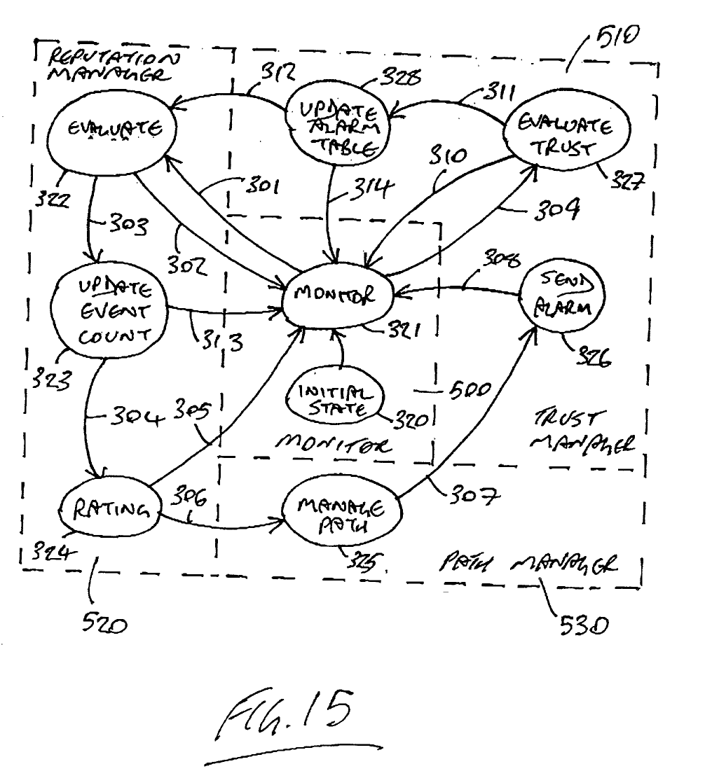

Referring now to FIG. 14, node A acknowledges the ALARM message received from node C as indicated at 233 and, based on the ALARM reroutes the data flow to the node E via node B.

It is desirable for each node 20 in the network 10 to be able to authenticate ALARM messages received from other node 20 in the network 10, in the interests of maintaining trust in the network 10 and to prevent the nodes 20 from denouncing each other. Such authentication may be achieved by the certification and validation function provided in PGP. It will be appreciated that other authentication schemes may be used.

As indicated earlier, in operation, each node 20 in the network 20 monitors the behavior of its next hop neighboring nodes.

Referring now to FIG. 15, in a preferred embodiment of the present invention, the monitoring is performed by the monitor 500 in each node 20 to detect suspicious network events.

At initialization, the monitor 500 changes from an initial state 320 to a monitoring state 321. If a suspicious event is detected by the monitor 500, the monitor 500 informs the reputation manager 520 as shown at 301.

On receipt of notification of the event, the reputation manager 520 evaluates the notification at 322. If the notification is found to be significant for the node 20, then, as shown at 303, the reputation manager 520 updates an event count at 323. Otherwise, the control logic returns to the monitoring state 321 as shown at 302. The significance threshold can be defined for different types of node 20 according to, for example, the security requirements of the different types of node.

If the event count is updated, then the reputation manager 520 checks the updated event count to determine whether the event has occurred more often than a predefined event threshold. The event threshold is set sufficiently high to distinguish deliberate malicious behavior from simple coincidences such as collisions. If the occurrence threshold is exceeded, then, as shown at 304, the reputation manager 520 updates the rating of the node that caused the event in the rating table 160. Otherwise, the control logic returns to the monitoring state 321 as shown at 313. At 324, the reputation manager checks the rating now assigned to the node that caused the event in the rating table 160. If the rating is below a predefined tolerance limit, then, at 306, the notification is relayed to the path manager 530. Otherwise, the control logic returns to the monitoring state 321 as shown at 305.

On receipt of the notification at 325, the path manager 530 modifies the topology data 110 to remove all routes containing the intolerable node. The path manager 530 relays the notification to the trust manager 510 as shown at 307. On receipt of the notification, the trust manager 510 may send an ALARM message describing the event as shown at 326. The control logic then returns to the monitoring state 321 as shown at 308.

When the monitor 500 receives an ALARM message from another node, it passes the message on to the trust manager 510 as shown at 309. On receipt of the message, the trust manager 510 evaluates, at 327, the source of the message. If the source is at least partially trusted, then, at 311, the message is passed into an ALARM table which is thus updated as shown 328. If the source is not trusted, then the control logic returns to a monitoring state as shown at 310. If there is sufficient evidence that the source reported in the message is malicious, then, at 312, the trust manager 90 sends the message to the reputation manager 520 where the event described is evaluated for significance, number of occurrences and accumulated reputation as herein before described. Otherwise, the control logic returns to the monitoring state 321 as shown at 314. The sufficiency of the evidence depends on the level of trust associated with the source of the message. It will be appreciated that several partially trusted nodes may report the same event. The partial trusts assigned to each may combine to equal or exceed that of a fully trusted node. In those circumstances, a particularly preferred embodiment of the present invention treats the event reported by the partially trusted node as if it had been reported by a single fully trusted node.

Embodiments of the present invention have been herein before described with reference to an ad hoc data processing network. However, it will be appreciated that the present invention is equally applicable to many other forms of data processing network, data communications, and distributed data processing functions. The term data processing as used herein should therefore be construed accordingly. Indeed, it will be appreciated that many changes may be made to the embodiments of the present invention described herein without departing from the scope of the invention.

References

[1] Jean-Pierre Hubauz, Jean-Yves Le Boudec, Silvia Giordano, and Mahaer Hamdi: “The Terminodes Project: Towards Mobile Ad-Hoc WANS”, Proceedings of MOMUC'99 San Diego, 1999.

[2] Mobile Ad Hoc Networks (MANET) Charter WG IETF, www.ietf.org.

[3] William Stallings. “Network and Inter network Security”. IEEE Press, Second Edition, 1995.

[4] Andreas Fasbender, Dogan Klesdogna, and Olaf Kubitz. “Variable and Scalable Security: Protection of Location Information in Mobile IP”. Proceedings of the 46th IEEE Vehicular Technology Conference, Atlanta, pp963-967, 1996.

[5] Ross Anderson and Frank Stajano. “The Resurrecting Duckling”. Lecture notes in Computer Science, Springer-Verlag, 1999.

[6] Zygmunt Haas. “Securing Ad-Hoc Networks”, IEEE Magazine, Special Issue on Networking Security, Vol.13, No.6, November/December, pages 24-30, 1999.

[7] Bradley R. Smith, Shree Murthy, and J. J. Garcia-Luna-Aceves. “Securing Distance-Vector Routing Protocols”, Proceeding of Internet Society Symposium on Network and Distributed System Security, San Diego, Calif., pages 85-92, February 1997.

[8] Levente Buttyan and Jean-Pierre Hubvaux. “Enforcing Service Availability in Mobile Ad-Hoc WANs”. MobiHOC, 2000.

[9] Sergio Marti, T. J. Giuli, Kevin Lai, Mary Baker. “Mitigating Misbehavior in Mobile Ad Hoc Networks”. Proceedings of MOBICOM 2000, PP255-265, 2000.

[10] Richard Dawkins, “The Selfish Gene”, Oxford University Press, 1989 edition, 1976.

[11] Matt Blaze, Joan Feigenbaum, and Jack Lacy. “Decentralized Trust Management”. Proceedings of IEEE Conference on Security and Privacy, Oakland, Calif., 1996.

[12] P. Zimmerman. PGP User's Guide. 1993.

1. Method for security management in a node of a data processing network comprising a plurality of nodes, wherein each node maintains topology data representing the network, the method comprising:
evaluating an event received by the node from a neighboring node in the network to determine if the event satisfies a predetermined security test; and,
if the event fails the security test, modifying an entry associated with the neighboring node in the topology data maintained by the node, and sending an alarm notification indicative of the security failure to other nodes of the network.

2. Method as claimed in claim 1, wherein the sending step includes sending the alarm notification to all nodes of the network.

3. Method as claimed in claim 1, wherein the evaluating of the event received from the neighboring node comprises:
counting the number of occurrences of the event in a predetermined time interval;
incrementing a rating of the neighboring node if the number of occurrences exceeds a predetermined event occurrence threshold; and,
determining that the event fails the security test if the rating of the neighboring node exceeds a predetermined rating threshold.

4. Method as claimed in claim 1, comprising:
receiving an alarm notification generated by another node in the network, the received alarm notification being indicative of an event caused by a further node in the network;
evaluating the alarm notification received generated by the other node to determine if the other node satisfies a predetermined trust test, and,
evaluating the event indicated by the alarm notification if the other node passes the trust test to determine if the event indicated by the alarm notification satisfies the security test; and,
if the event fails the security test, modifying the topology data associated with the event causing node in the topology data maintained by the node, and sending another alarm notification indicative of the security failure to other nodes of the network.

5. Method as claimed in claim 4, wherein the evaluating of the event indicated by the alarm notification comprises:
counting the number of occurrences of the event indicated by the alarm notification in a predetermined time interval;
incrementing a rating of the event causing node if the number of occurrences exceeds a predetermined event occurrence threshold; and,
determining that the event fails the security test if the rating of the event causing node exceeds a predetermined rating threshold.

6. Computer program product comprising a computer readable medium having embodied therein computer readable program code means for causing a processor of a node in a data processing network comprising a plurality of nodes to perform a method for security management in the node, wherein each node maintains topology data representing the network, the method comprising:
evaluating an event received by the node from a neighboring node in the network to determine if the event satisfies a predetermined security test; and,
if the event fails the security test, modifying an entry associated with the neighboring node in the topology data maintained by the node, and sending an alarm notification indicative of the security failure to any other nodes of the network.

7. Computer program product as claimed in claim 6, wherein the sending step includes sending the alarm notification to all nodes in the network.

8. Computer program product as claimed in claim 6, wherein the evaluating of the event received from the neighboring node comprises:
counting the number of occurrences of the event in a predetermined time interval;
incrementing a rating of the neighboring node if the number of occurrences exceeds a predetermined event occurrence threshold; and,
determining that the event fails the security test if the rating of the neighboring node exceeds a predetermined rating threshold.

9. Computer program product as claimed in claim 6, comprising:
receiving an alarm notification generated by another node in the network, the received alarm notification being indicative of an event caused by a further node in the network;
evaluating the alarm notification generated by the other node to determine if the other node satisfies a predetermined trust test, and,
evaluating the event indicated by the alarm notification if the other node passes the trust test to determine if the event indicated by the alarm notification satisfies the security test; and,
if the event indicated by the alarm notification fails the security test, modifying the topology data associated with the event causing node in the topology data maintained by the node, and sending another alarm notification indicative of the security failure to other nodes of the network.

10. Computer program product as claimed in claim 9, wherein the evaluating of the event indicated by the alarm notification comprises:
counting the number of occurrences of the event indicated by the alarm notification in a predetermined time interval;
incrementing a rating of the event causing node if the number of occurrences exceeds a predetermined event occurrence threshold; and,
determining that the event indicated by the alarm notification fails the security test if the rating of the event causing node exceeds a predetermined rating threshold.

11. Apparatus for security management in a node of a data processing network comprising a plurality of nodes, wherein each node maintains topology data representing the network, the apparatus comprising control logic configured to evaluate an event received by the node from a neighboring node in the network to determine if the event satisfies a predetermined security test, to modify an entry associated with the neighboring node in the topology data maintained by the node if the event fails the security test, and to send an alarm notification indicative of the security failure to other nodes in the network.

12. Apparatus as claimed in claim 11, wherein the control logic is configured to send the alarm notification to all nodes of the network.

13. Apparatus as claimed in claim 11, wherein the control logic is configured such that evaluating the event received from the neighboring node comprises counting the number of occurrences of the event in a predetermined time interval, incrementing a rating of the neighboring node if the number of occurrences exceeds a predetermined event occurrence threshold, and, determining that the event fails the security test if the rating of the neighboring node exceeds a predetermined rating threshold.

14. Apparatus as claimed in claim 11, wherein the control logic is configured: to receive an alarm notification generated by another node in the network, the received alarm notification being indicative of an event caused by a further node in the network; to evaluate the received alarm notification to determine if the other node satisfies a predetermined trust test; to evaluate the event indicated by the alarm notification if the other node passes the trust test to determine if the event indicated by the alarm notification satisfies the security test; to modify the topology data associated with the event causing node in the topology data maintained by the node if the event indicated by the alarm notification fails the security test; and, to send another alarm notification indicative of the security failure to other nodes of the network.

15. Apparatus as claimed in claim 14, wherein the control logic is configured such that evaluating of the event indicated by the alarm notification comprises: counting the number of occurrences of the event indicated by the alarm notification in a predetermined time interval; incrementing a rating of the event causing node if the number of occurrences exceeds a predetermined event occurrence threshold; and, determining that the event indicated by the alarm notification fails the security test if the rating of the event causing node exceeds a predetermined rating threshold.

16. Apparatus as claimed in claim 11, further comprising a memory for storing the topology data.

17. Data processing node for connection to a data processing network comprising a plurality of nodes, wherein each node maintains topology data representing the network, the data processing node comprising: a memory for storing the topology data; and, security management control logic connected to the memory and configured to evaluate an event received by the node from a neighboring node in the network to determine if the event satisfies a predetermined security test, to modify an entry associated with the neighboring node in the topology data stored in the memory if the event fails the security test, and to send an alarm notification indicative of the security failure to other nodes of the network.

18. Data processing node as claimed in claim 17, wherein the control logic is configured to send the alarm notification to all neighboring nodes.

19. Data processing node as claimed in claim 17, wherein the control logic is configured such that evaluating the event received from the neighboring node comprises counting the number of occurrences of the event in a predetermined time interval, incrementing a rating of the neighboring node if the number of occurrences exceeds a predetermined event occurrence threshold, and, determining that the event fails the security test if the rating of the neighboring node exceeds a predetermined rating threshold.

20. Data processing node as claimed in claim 17, wherein the control logic is configured: to receive an alarm notification generated by another node in the network, the received alarm notification being indicative of an event caused by a further node in the network; to evaluate the received alarm notification to determine if the other node satisfies a predetermined trust test; to evaluate the event indicated by the alarm notification if the other node passes the trust test to determine if the event indicated by the alarm notification satisfies the security test; to modify the topology data associated with the event causing node in the topology data stored in the memory if the event indicated by the alarm notification fails the security test; and, to send another alarm notification indicative of the security failure to other nodes of the network.

21. Data processing node as claimed in claim 20, wherein the control logic is configured such that evaluating of the event indicated by the alarm notification comprises: counting the number of occurrences of the event indicated by the alarm notification in a predetermined time interval; incrementing a rating of the event causing node if the number of occurrences exceeds a predetermined event occurrence threshold; and, determining that the event indicated by the alarm notification fails the security test if the rating of the event causing node exceeds a predetermined rating threshold.

22. Data processing network comprising a plurality of data processing nodes, wherein each node maintains topology data representing the network, each of the data processing nodes comprising: a memory for storing the topology data; and, security management control logic connected to the memory and configured to evaluate an event received by the node from a neighboring node in the network to determine if the event satisfies a predetermined security test, to modify an entry associated with the neighboring node in the topology data stored in the memory if the event fails the security test, and to send an alarm notification indicative of the security failure to any other nodes of the network.

23. Data processing network as claimed in claim 22, wherein the control logic is configured to send the alarm notification to all nodes of the network.

24. Data processing network as claimed in claim 22, wherein the control logic is configured such that evaluating the event received from the neighboring node comprises counting the number of occurrences of the event in a predetermined time interval, incrementing a rating of the neighboring node if the number of occurrences exceeds a predetermined event occurrence threshold, and, determining that the event fails the security test if the rating of the neighboring node exceeds a predetermined rating threshold.

25. Data processing network as claimed in claim 22, wherein the control logic is configured: to receive an alarm notification generated by another node in the network, the received alarm notification being indicative of an event caused by a further node in the network; to evaluate the received alarm notification to determine if the other node satisfies a predetermined trust test; to evaluate the event indicated by the alarm notification if the other node passes the trust test to determine if the event indicated by the alarm notification satisfies the security test; modifying the topology data associated with the event causing node in the topology data stored in the memory if the event indicated by the alarm notification fails the security test; and, to send another alarm notification indicative of the security failure to other nodes of the network.

26. Data processing node as claimed in claim 25, wherein the control logic is configured such that evaluating of the event indicated by the alarm notification comprises: counting the number of occurrences of the event indicated by the alarm notification in a predetermined time interval; incrementing a rating of the event causing node if the number of occurrences exceeds a predetermined event occurrence threshold; and, determining that the event indicated by the alarm notification fails the security test if the rating of the event causing node exceeds a predetermined rating threshold.
